(19) United States
(12) Patent Application Publication
(10) Pub. No.: US 2026/0128400 A1
(43) Pub. Date: May 7, 2026

(54) POWER STORAGE DEVICE

(71) Applicant: TOYOTA JIDOSHA KABUSHIKI KAISHA, Toyota-shi (JP)

(72) Inventor: Keisuke Sakashita, Toyota-shi (JP)

(73) Assignee: TOYOTA JIDOSHA KABUSHIKI KAISHA, Toyota-shi (JP)

(21) Appl. No.: 19/364,180

(22) Filed: Oct. 21, 2025

(30) Foreign Application Priority Data
Nov. 5, 2024 (JP) 2024-193692

(51) Int. Cl. H01M 10/48; H01M 50/204; H01M 50/507; H01M 50/519

(52) U.S. Cl. CPC H01M 10/486; H01M 10/482; H01M 50/204; H01M 50/507; H01M 50/519

(57) ABSTRACT

A temperature detection unit includes a first temperature detection portion disposed on a first direction side with respect to a module center, and a second temperature detection portion disposed on a second direction side with respect to the module center. A first detection connector is electrically connected to the first temperature detection portion and is disposed on the first direction side with respect to a module main body. A second detection connector is electrically connected to a second temperature detection portion and is disposed on the second direction side with respect to the module main body.

### CROSS REFERENCE TO RELATED APPLICATIONS

This nonprovisional application is based on Japanese Patent Application No. 2024-193692 filed on November 5, 2024 with the Japan Patent Office, the entire contents of which are hereby incorporated by reference.

### BACKGROUND

### Field

The present disclosure relates to a power storage device.

### Description of the Background Art

Japanese Patent Laying-Open No. 2024-085194 discloses a secondary battery in which a plurality of battery cells are arranged. The secondary battery includes a bus bar that connects positive electrodes at one end of each battery cell and negative electrodes at the other end of each battery cell. A temperature detection portion, which is a sensor for detecting the temperature of the bus bar, is disposed in the bus bar. A signal from the temperature detection portion disposed in each bus bar is transmitted to a connector provided outside the flexible substrate through the flexible substrate.

### SUMMARY

In the secondary battery (power storage device) described in Japanese Patent Laying-Open No. 2024-085194, the signal is transmitted to the connector from the temperature detection portion disposed in the bus bar at each of the both ends of the battery cell (power storage cell) as described above. For example, when (the pin of) the connector is disposed to face the one end side, it is considered to be difficult to electrically connect the temperature detection portion on the other end side to the connector. Specifically, in order to electrically connect the temperature detection portion on the other end side and the connector by a flexible substrate, the flexible substrate needs to be rounded to reach the one end side. Thus, it is considered that the secondary battery becomes large.

The present disclosure has been made to solve the above-described problem, and an object of the present disclosure is to provide a power storage device so as to readily electrically connect a detection module disposed on one end side of a cell module in an arrangement direction of power storage cells and temperature detection portions on both sides in an intersecting direction intersecting the arrangement direction when the temperature detection portions are provided on the both sides.

A power storage device according to one aspect of the present disclosure includes: a cell module including a plurality of power storage cells arranged in an arrangement direction; a bus bar module electrically connected to the cell module; a temperature detection unit; and at least one detection module electrically connected to the temperature detection unit and disposed on one end side of the cell module in the arrangement direction. When it is defined that a direction intersecting the arrangement direction is an intersecting direction, one direction of the intersecting direction is a first direction, and the other direction of the intersecting direction is a second direction, the bus bar module includes a plurality of first bus bars disposed on the first direction side with respect to a module center located at a center of the cell module in the intersecting direction, and a plurality of second bus bars disposed on the second direction side with respect to the module center. The temperature detection unit includes a first temperature detection portion disposed on the first direction side with respect to the module center, the first temperature detection portion being able to detect a temperature of at least one of the plurality of first bus bars, and a second temperature detection portion disposed on the second direction side with respect to the module center, the second temperature detection portion being able to detect a temperature of at least one of the plurality of second bus bars. The detection module includes a module main body, and a first detection connector and a second detection connector each connected to the module main body. The first detection connector is electrically connected to the first temperature detection portion and is disposed on the first direction side with respect to the module main body. The second detection connector is electrically connected to the second temperature detection portion and is disposed on the second direction side with respect to the module main body.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a configuration of a power storage device according to the present embodiment.

FIG. 2 is a plan view showing a detailed configuration of the power storage device.

FIG. 3 is a partially enlarged view showing a cell module and a detection module of FIG. 2.

FIG. 4 is a partially enlarged view showing a configuration in the vicinity of a detection module shown in FIG. 2.

FIG. 5 is a diagram showing a pin arrangement of the detection connector on the X1 side.

FIG. 6 is a diagram showing a pin arrangement of the detection connector on the X2 side.

### DESCRIPTION OF THE PREFERRED EMBODIMENTS

Embodiments of the present disclosure will be described with reference to the drawings. In the drawings referred to below, the same or corresponding members are denoted by the same reference numerals.

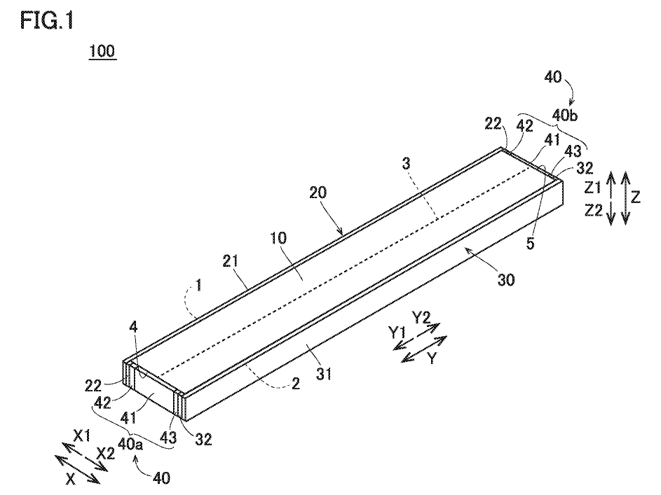

FIG. 1 is a diagram illustrating a configuration of a power storage device 100 according to the present embodiment. The power storage device 100 is mounted on, for example, a vehicle (not shown). The vehicle may be PHEV (Plug-in Hybrid Electric Vehicle), BEV (Battery Electric Vehicle), FCEV (Fuel Cell Electric Vehicle), and the like. Note that the use of the power storage device 100 is not limited to vehicle use.

In the present specification, the X direction, the Y direction, and the Z direction are directions orthogonal to each other. For example, the X direction may be a front-rear direction of the vehicle in a state in which the power storage device 100 is mounted on the vehicle. The Y direction may be a left-right direction of the vehicle in a state in which the power storage device 100 is mounted on the vehicle. The Z direction may be an up-down direction in a state in which the power storage device 100 is mounted on a vehicle. For example, the Z1 direction and the Z2 direction may be upward and downward, respectively. The X direction may be the left-right direction, and the Y direction may be the front-rear direction. The X direction and the Y direction are examples of the "intersecting direction" and the "arrangement direction" in the present disclosure, respectively.

The power storage device 100 includes a cell module 10, a bus bar module 20, a bus bar module 30, and a detection module 40. Each of the bus bar module 20 and the bus bar module 30 is electrically connected to the cell module 10.

The cell module 10 includes a side surface (first side surface) 1 and a side surface (second side surface) 2. The side surface 1 is a side surface of the cell module 10 on the X1 side. The side surface 2 is a side surface of the cell module 10 on the X2 side. The X1 side and the X2 side are the one direction side and the other direction side in the X direction, respectively. The X1 direction and the X2 direction are examples of the "first direction" and the "second direction" in the present disclosure, respectively. The side surface 1 and the side surface 2 are examples of the "first side surface" and the "second side surface" of the present disclosure, respectively.

The bus bar module 20 is disposed on the X1 side with respect to the module center 3 (indicated by a broken line in FIG. 1) located at the center in the X direction in the cell module 10. The bus bar module 30 is disposed on the X2 side with respect to the module center 3.

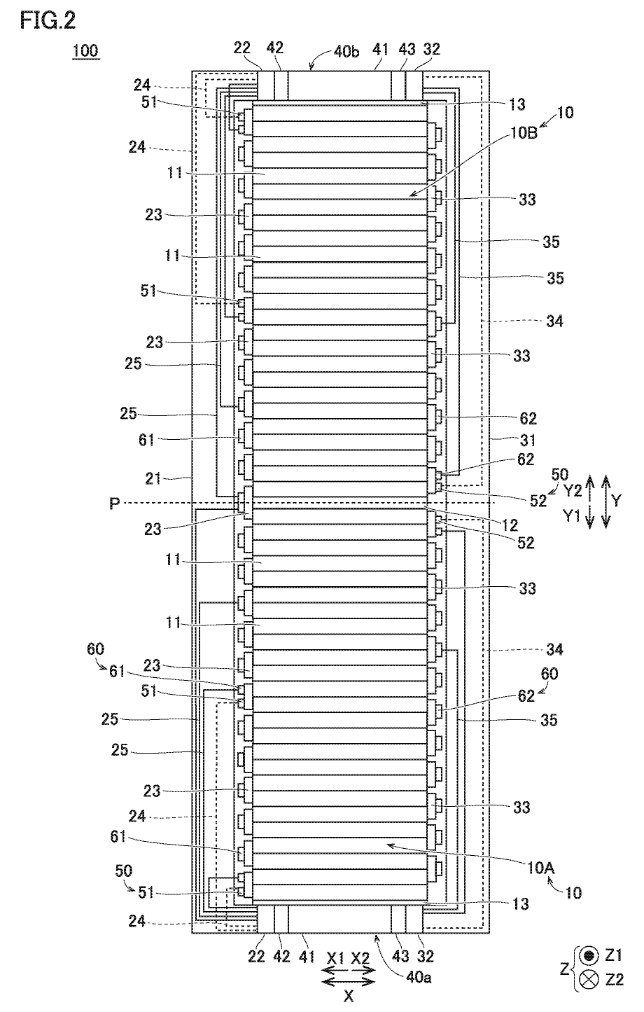

The bus bar module 20 includes a printed board (first printed board) 21, two bus bar connectors (first bus bar connectors) 22, and a plurality of bus bars (first bus bars) 23 (FIG. 2). The printed board 21 and the bus bar connector 22 are examples of the "first printed board" and the "first bus bar connector" in the present disclosure, respectively. The bus bar 23 is an example of the "first bus bar" in the present disclosure.

The printed board 21 is disposed at a position facing the side surface 1 of the cell module 10. Specifically, the printed board 21 and the side surface 1 face each other in the X direction. Each of the printed board 21 and the side surface 1 intersects (is orthogonal to) the X direction.

One and the other of the two bus bar connectors 22 are disposed at an end portion on the Y1 side and an end portion on the Y2 side of the printed board 21, respectively. The Y1-side bus bar connector 22 is located on the Y1 side with respect to the Y1-side end portion (one end) 4 of the cell module 10. The Y2-side bus bar connector 22 is located on the Y2 side with respect to the Y2-side end portion (one end) 5 of the cell module 10. Each of the end portion 4 and the end portion 5 is an example of the "one end" in the present disclosure.

The bus bar module 30 includes a printed board (second printed board) 31, two bus bar connectors (second bus bar connectors) 32, and a plurality of bus bars (second bus bars) 33 (FIG. 2). The printed board 31 and the bus bar connector 32 are examples of the "second printed board" and the "second bus bar connector" in the present disclosure, respectively. The bus bar 33 is an example of the "second bus bar" in the present disclosure.

The printed board 31 is disposed at a position facing the side surface 2 of the cell module 10. Specifically, the printed board 31 and the side surface 2 face each other in the X direction. Each of the printed board 31 and the side surface 2 intersects (is orthogonal to) the X direction.

One and the other of the two bus bar connectors 32 are disposed at an end portion on the Y1 side and an end portion on the Y2 side of the printed board 31, respectively. The bus bar connector 32 on the Y1 side is located on the Y1 side with respect to the end portion 4 of the cell module 10. The bus bar connector 32 on the Y2 side is located on the Y2 side with respect to the end portion 5 of the cell module 10.

The detection module 40 includes a detection module (first detection module) 40a and a detection module (second detection module) 40b. Each of the detection module 40a and the detection module 40b is electrically connected to each of the bus bar module 20 and the bus bar module 30. The detection module 40a and the detection module 40b have the same configuration. In the following description, the detection module 40 is common to the detection module 40a and the detection module 40b. The detection module 40a and the detection module 40b are examples of the "first detection module" and the "second detection module" in the present disclosure, respectively.

The detection module 40a is disposed on the end portion 4 side of the cell module 10. Specifically, the detection module 40a is disposed on the Y1 side with respect to the end portion 4. The detection module 40a and the end portion 4 face each other in the Y direction. The detection module 40b is disposed on the end portion 5 side of the cell module 10. Specifically, the detection module 40b is disposed on the Y2 side with respect to the end portion 5. The detection module 40b and the end portion 5 face each other in the Y direction.

The detection module 40 includes a module main body 41, a detection connector (first detection connector) 42, and a detection connector (second detection connector) 43. Each of the detection connector 42 and the detection connector 43 is connected to the module main body 41. The detection connector 42 and the detection connector 43 are examples of the "first detection connector" and the "second detection connector" in the present disclosure, respectively.

The detection connector 42 is disposed on the X1 side with respect to the module main body 41. The detection connector 43 is disposed on the X2 side with respect to the module main body 41. That is, the module main body 41 is disposed between the detection connector 42 and the detection connector 43 in the X direction.

The module main body 41 is disposed at a position overlapping the cell module 10 in the Y direction. Each of the detection connector 42 and the detection connector 43 is also disposed at a position overlapping the cell module 10 in the Y direction. Specifically, the detection module 40 is within a range between the position where the side surface 1 of the cell module 10 is disposed and the position where the side surface 2 is disposed in the X direction. Each of the bus bar connector 22 and the bus bar connector 32 is also disposed at a position within the above range in the X direction.

Accordingly, the power storage device 100 can be easily reduced in size as compared with the case where the module main body 41 (detection module 40) is disposed at a position shifted in the X direction with respect to the cell module 10.

The detection connector 42 of the detection module 40 is connected to the bus bar connector 22. The detection connector 43 of the detection module 40 is connected to the bus bar connector 32.

FIG. 2 is a schematic plan view showing a detailed configuration of the power storage device 100. The cell module 10 includes a plurality of (in the present embodiment, 50) power storage cells 11, a plate 12, and a pair of end plates 13. The plurality of power storage cells 11 are arranged in the X direction. In FIG. 2, the thicknesses of the printed board 21 and the printed board 31 are shown to be larger than the actual thicknesses, and the wirings are shown to be shifted from each other, in order to facilitate understanding of the wiring described later.

The plate 12 is disposed at the center of the plurality of power storage cells 11. The position of the plate 12 in the Y direction is defined as a position (predetermined position) P. In each of the regions on the Y1 side and the Y2 side of the plate 12, 25 power storage cells 11 are arranged. The cell module 10 includes a cell module 10A including 25 power storage cells 11 on the Y1 side with respect to the plate 12, and a cell module 10B including 25 power storage cells 11 on the Y2 side with respect to the plate 12. The plate 12 is made of resin, for example. The position P is an example of the "predetermined position" in the present disclosure.

The cell module 10 is sandwiched between a pair of end plates 13. One of the pair of end plates 13 is disposed between the end portion 4 (FIG. 1) of the cell module 10 and the detection module 40a. The other of the pair of end plates 13 is disposed between the end portion 5 (FIG. 1) of the cell module 10 and the detection module 40b.

The detection module 40a receives a signal described later indicating the temperature, voltage, and the like of the power storage cell 11 of the cell module 10A. The detection module 40b receives a signal described later indicating the temperature, voltage, and the like of the power storage cell 11 of the cell module 10B.

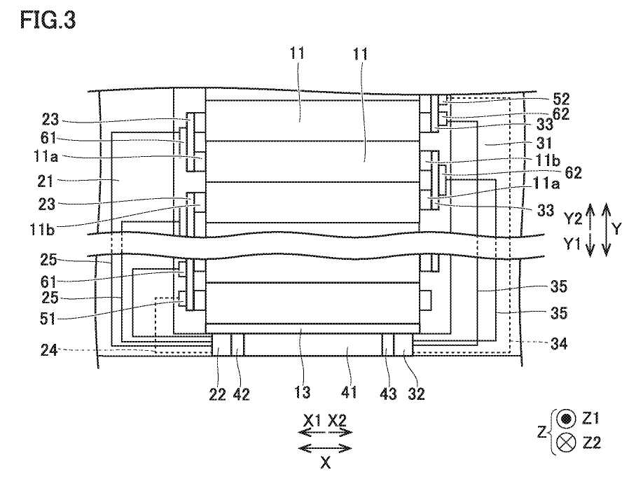

FIG. 3 is a partially enlarged view of FIG. 2. As illustrated in FIG. 3, each of the plurality of power storage cells 11 includes an electrode terminal 11a and an electrode terminal 11b. One of the electrode terminal 11a and the electrode terminal 11b is a positive electrode terminal, and the other of the electrode terminal 11a and the electrode terminal 11b is a negative electrode terminal. The electrode terminal 11a is disposed at one end portion of each power storage cell 11 in the X direction. The electrode terminal 11a is disposed at the other end portion of each power storage cell 11 in the X direction.

The plurality of power storage cells 11 are arranged so that their directions in the X direction are alternately reversed. That is, the power storage cells 11 in which the electrode terminals 11a are disposed on the X1 side and the electrode terminals 11b are disposed on the X2 side and the power storage cells 11 in which the electrode terminals 11a are disposed on the X2 side and the electrode terminals 11b are disposed on the X1 side are alternately disposed in the Y direction. The electrode terminals 11a and 11b disposed on the X1 side are disposed on the side surface 1 of the cell module 10. The electrode terminals 11a and 11b disposed on the X2 side are disposed on the side surface 2 of the cell module 10.

Each of the plurality of bus bars 23 connects the electrode terminal 11a of one power storage cell 11 and the electrode terminal 11b of the other power storage cell 11 among the power storage cells 11 arranged in the Y direction. Only one of the plurality of bus bars 23 connects the electrode terminals 11a and 11b of the two power storage cells 11 disposed on both sides of the plate 12 in the Y direction. That is, only one of the bus bars 23 extends across the plate 12 (see FIG. 2). In FIGS. 2 and 3, the bus bar 23 is illustrated as being disposed at a position closer to the power storage cell 11 than the printed board 21, but the present disclosure is not limited to this example. For example, the bus bar 23 and the printed board 21 may be disposed at positions overlapping each other in the Z direction. The bus bar 33 and the printed board 31 may be the same.

Each of the plurality of bus bars 33 connects the electrode terminal 11a of one power storage cell 11 and the electrode terminal 11b of the other power storage cell 11 among the power storage cells 11 arranged in the Y direction.

The 50 power storage cells 11 arranged in the Y direction are electrically connected in series by the plurality of bus bars 23 and the plurality of bus bars 33.

Referring to FIG. 2 again, the power storage device 100 includes a temperature detection unit 50 and a voltage detection unit 60. Each of the temperature detection unit 50 and the voltage detection unit 60 is electrically connected to the detection module 40.

The temperature detection unit 50 includes at least one temperature sensor (first temperature detection portion) 51 and at least one temperature sensor (second temperature detection portion) 52. The temperature sensor 51 and the temperature sensor 52 are disposed symmetrically with respect to the plate 12 in the Y direction. The temperature sensor 51 and the temperature sensor 52 are examples of the "first temperature detection portion" and the "second temperature detection portion" in the present disclosure, respectively.

The temperature sensor 51 is disposed on the X1 side with respect to the module center 3 (FIG. 1). Specifically, the temperature sensor 51 is disposed in a part of the plurality of bus bars 23. Specifically, the temperature sensor 51 is disposed in a bus bar 23 disposed at a position closest to the detection module 40 among the plurality of bus bars 23, and in a bus bar 23 corresponding to a central position in the Y direction of the cell module 10A (cell module 10B). That is, the temperature sensors 51 are disposed in four of the plurality of bus bars 23. The temperature sensor 51 detects the temperature of the bus bar 23 in which the temperature sensor 51 is disposed.

The temperature sensor 52 is disposed on the X2 side with respect to the module center 3 (FIG. 1). Specifically, the temperature sensor 52 is disposed in a part of the plurality of bus bars 33. Specifically, the temperature sensor 52 is disposed on the bus bar 33 disposed at a position closest to the plate 12 among the plurality of bus bars 33. That is, two temperature sensors 52 are disposed among the plurality of bus bars 33. The temperature sensor 52 detects the temperature of the bus bar 33 in which the temperature sensor 52 is disposed.

Here, in the conventional power storage device, when the (pin of) detection connector of the detection module is disposed so as to face, for example, the X1 side, it is considered to be difficult to electrically connect the sensor on the X2 side and the detection connector.

Therefore, in the present embodiment, the detection connector 42 disposed on the X1 side of the module main body 41 is electrically connected to the temperature sensor 51. The detection connector 43 disposed on the X2 side of the module main body 41 is electrically connected to the temperature sensor 52.

Specifically, a wiring (first wiring) 24 and a wiring 25 are formed on the printed board 21. The wiring 24 electrically connects the temperature sensor 51 and the bus bar connector 22. Each of the wiring 24 and the wiring 25 is a pattern (metal foil or the like) formed on the printed board 21. In FIG. 2, the wiring 24 is represented by a broken line, and the wiring 25 is represented by a solid line. The wiring 24 is an example of the "first wiring" in the present disclosure.

A wiring (second wiring) 34 and a wiring 35 are formed on the printed board 31. The wiring 34 electrically connects the temperature sensor 52 and the bus bar connector 32. Each of the wiring 34 and the wiring 35 is a pattern (metal foil or the like) formed on the printed board 31. In FIG. 2, the wiring 34 is represented by a broken line, and the wiring 35 is represented by a solid line. The wiring 34 is an example of the "second wiring" in the present disclosure.

The detection connector 42 of the detection module 40a is electrically connected to the temperature sensor 51 disposed on the Y1 side with respect to the position P where the plate 12 is disposed in the Y direction. The detection connector 43 of the detection module 40a is electrically connected to the temperature sensor 52 disposed on the Y1 side with respect to the position P in the Y direction. The detection connector 42 of the detection module 40b is electrically connected to the temperature sensor 51 disposed on the Y2 side with respect to the position P in the Y direction. The detection connector 43 of the detection module 40b is electrically connected to the temperature sensor 52 disposed on the Y2 side with respect to the position P in the Y direction.

Accordingly, the temperature sensor and the detection connector can be easily connected to each other in the regions on both sides of the Y1 side and the Y2 side of the cell module 10, and the wiring structure can be simplified.

The voltage detection unit 60 includes a plurality of voltage sensors 61 and a plurality of voltage sensors 62. The voltage sensor 61 is disposed in each bus bar 23. The voltage sensor 62 is disposed in each bus bar 33. A voltage sensor 61 is also disposed on the bus bar 23 on which the temperature sensor 51 is disposed. A voltage sensor 62 is also disposed on the bus bar 33 on which the temperature sensor 52 is disposed. The temperature sensor 51 and the voltage sensor 61 disposed in the common bus bar 23 may be integrally formed. The temperature sensor 52 and the voltage sensor 62 disposed in the common bus bar 33 may be integrally formed.

The voltage sensor 61 may detect a voltage of the bus bar 23 in which the voltage sensor 61 is disposed (a voltage difference between the power storage cells 11 connected by the bus bar 23). The voltage sensor 61 may detect the voltage of each of the two power storage cells 11 connected by the bus bar 23. In this regard, the voltage sensor 62 may be similar to the voltage sensor 61.

The wiring 25 of the printed board 21 electrically connects the voltage sensor 61 and the bus bar connector 22. The wiring 35 of the printed board 31 electrically connects the voltage sensor 62 and the bus bar connector 32.

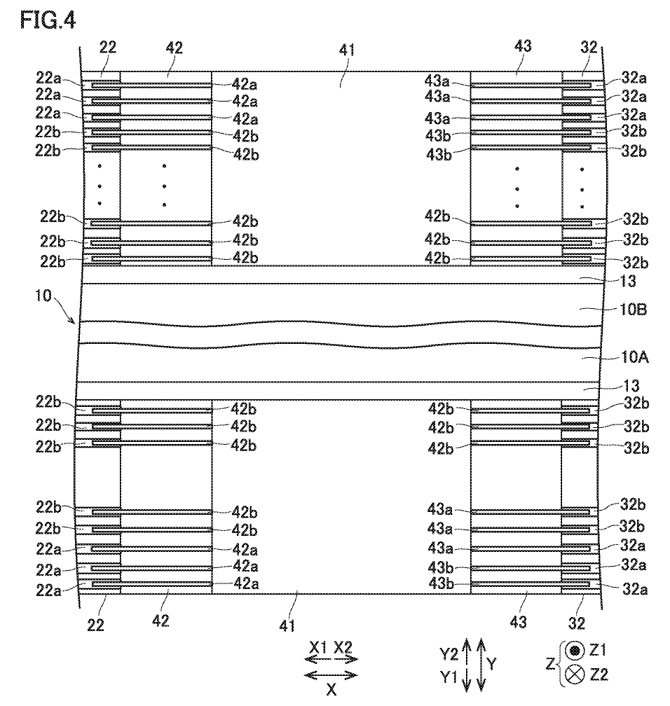

FIG. 4 is a schematic diagram showing a detailed configuration of the detection connectors (42, 43) and the bus bar connectors (22, 32). In FIG. 4, for simplicity, some of the pins described later are omitted.

The bus bar connector 22 has at least one temperature pin 22a and a plurality of voltage pins 22b. In the present embodiment, the bus bar connector 22 has three temperature pins 22a. Two of the three temperature pins 22a are electrically connected to the wiring 24 (FIG. 2).

The bus bar connector 32 has at least one temperature pin 32a and a plurality of voltage pins 32b. In the present embodiment, the bus bar connector 32 has three temperature pins 32a. One of the three temperature pins 32a is electrically connected to the wiring 34 (FIG. 2).

The detection connector 42 includes at least one temperature pin (first detection pin) 42a and a plurality of voltage pins 42b. In the present embodiment, the detection connector 42 has three temperature pins 42a. The temperature pin 42a is a pin for temperature detection, and the voltage pin 42b is a pin for voltage detection. Each temperature pin 42a is in contact with (electrically connected to) any one of the three temperature pins 22a of the bus bar connector 22. Each voltage pin 42b is in contact with (electrically connected to) any one of the plurality of voltage pins 22b of the bus bar connector 22. The temperature pin 42a is an example of the "first detection pin" in the present disclosure.

Thus, two of the three temperature pins 42a are electrically connected to the temperature sensor 51 (FIG. 2) through the wiring 24 (FIG. 2) and the temperature pin 22a. Accordingly, the two temperature pins 42a receive (acquire) a signal indicating the temperature of the bus bar 23 (FIG. 2) detected by the temperature sensor 51. Each voltage pin 42b is electrically connected to the voltage sensor 61 (FIG. 2) through the wiring 25 (FIG. 2) and the voltage pin 22b. Accordingly, the voltage pin 42b receives (obtains) a signal indicating the voltage of the bus bar 23 detected by the voltage sensor 61.

The detection connector 43 includes at least one temperature pin (second detection pin) 43a and a plurality of voltage pins 43b. In the present embodiment, the detection connector 43 has three temperature pins 43a. The temperature pin 43a is a pin for temperature detection, and the voltage pin 43b is a pin for voltage detection. Each temperature pin 43a is in contact with (electrically connected to) any one of the three temperature pins 32a of the bus bar connector 32. Each voltage pin 43b is in contact with (electrically connected to) any one of the plurality of voltage pins 32b of the bus bar connector 32. The temperature pin 43a is an example of the "second detection pin" in the present disclosure.

Thus, one of the three temperature pins 43a is electrically connected to the temperature sensor 52 (FIG. 2) through the wiring 34 (FIG. 2) and the temperature pin 32a. Accordingly, the one temperature pin 43a receives (obtains) a signal indicating the temperature of the bus bar 33 (FIG. 2) detected by the temperature sensor 52. Each voltage pin 43b is electrically connected to the voltage sensor 62 (FIG. 2) through the wiring 35 (FIG. 2) and the voltage pin 32b. Accordingly, each voltage pin 43b receives (obtains) a signal indicating the voltage of the bus bar 33 detected by the voltage sensor 62.

In the present embodiment, each of the number (3) of the temperature pins 42a and the number (3) of the temperature pins 43a is equal to the sum of the number (2) of the bus bars 23 whose temperature is detected by the temperature sensor 51 (FIG. 2) and the number (1) of the bus bars 33 whose temperature is detected by the temperature sensor 52 (FIG. 2). The number of bus bars 23 and the number of bus bars 33 mean the number of bus bars whose temperatures are detected in the respective cell modules (10A, 10B).

Accordingly, since each of the temperature pin 42a and the temperature pin 43a includes a redundant (preliminary) pin, even when an abnormality occurs in the temperature pin 42a and the temperature pin 43a during use, the redundant (preliminary) pin can be used instead.

Further, by providing the redundant (preliminary) pins, it is possible to easily increase the number of bus bars 23 (bus bars 33) whose temperature is detected.

Further, as shown in FIG. 4, the at least one temperature pin 42a may be provided on the side opposite to the cell module 10 with respect to the voltage pin 42b. The at least one temperature pin 43a may be provided on the opposite side of the cell module 10 with respect to the voltage pin 43b. The temperature pin 42a may be disposed at the same position as the temperature pin 43a in the Y direction. The positional relationship between the temperature pin 42a and the voltage pin 42b (the positional relationship between the temperature pin 43a and the voltage pin 43b) may be opposite to that in the above example.

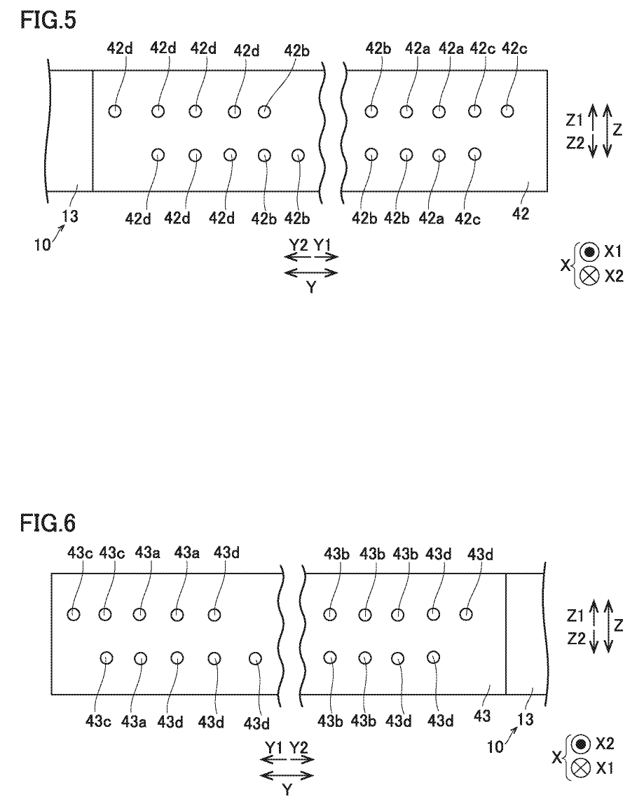

FIG. 5 is a diagram showing a pin arrangement of the detection connector 42. As shown in FIG. 5, a part (two in FIG. 5) of the three temperature pins 42a is disposed on the Z1 side of the remaining part (one in FIG. 5) of the three temperature pins 42a.

The detection connector 42 includes three pins 42c and a plurality of pins 42d. The pin 42c is a ground pin corresponding to the temperature pin 42a. A part (two in FIG. 5) of the three pins 42c is disposed on the Z1 side of the remaining part (one in FIG. 5) of the three pins 42c. The three pins 42c are disposed on the side opposite to the cell module 10 with respect to the three temperature pins 42a. The pin 42d is an unused pin or a pin for another use (for example, power supply).

FIG. 6 is a diagram showing a pin arrangement of the detection connector 43. As shown in FIG. 6, a part (two in FIG. 6) of the three temperature pins 43a is disposed on the Z1 side of the remaining part (one in FIG. 6) of the three temperature pins 43a.

The detection connector 43 includes three pins 43c and a plurality of pins 43d. The pin 43c is a pin for ground (grounding) corresponding to the temperature pin 43a. A part (two in FIG. 6) of the three pins 43c is disposed on the Z1 side of the remaining part (one in FIG. 6) of the three pins 43c. The three pins 43c are disposed on the side opposite to the cell module 10 with respect to the three temperature pins 43a. The pin 43d is an unused pin or a pin for another use (for example, ground corresponding to a power supply).

As described above, in the present embodiment, the detection connector 42 is electrically connected to the temperature sensor 51 and is disposed on the X1 side with respect to the module main body 41. The detection connector 43 is electrically connected to the temperature sensor 52, and is disposed on the X2 side with respect to the module main body 41. Thus, unlike, for example, the case where the temperature sensor 51 and the detection connector 43 are electrically connected (or the temperature sensor 52 and the detection connector 42 are electrically connected), the wiring connecting the temperature sensor and the detection connector may not be extended from one side to the other side of the cell module in the X direction. Therefore, it is possible to reduce the necessity of arranging the wirings so as to be wrapped around, and it is possible to easily suppress complication of the wirings (complication of the wirings). As a result, the temperature sensor and the detection connector can be easily connected to each other. Accordingly, the detection module 40 can be easily electrically connected to each of the temperature sensor 51 and the temperature sensor 52. In addition, since the wiring structure can be simplified and the wiring length can be reduced as described above, the power storage device 100 can be easily reduced in size.

The printed board 21 is disposed at a position facing the side surface 1 of the cell module 10, and the printed board 31 is disposed at a position facing the side surface 2 of the cell module 10. Accordingly, the width of the cell module 10 in the Z direction can be reduced (low-height can be achieved) as compared with the case where the printed board is disposed on the upper surface (the surface on the Z1 side) of the cell module 10. Therefore, the width in the Z direction of the cell module 10 can be reduced (low-height) while simplifying the wiring structure for electrically connecting the detection module 40 and each of the temperature sensor 51 and the temperature sensor 52. Thus, the above structure is particularly effective in suppressing an increase in size of the power storage device 100.

### Modification

Although an example in which the temperature sensor is disposed in the bus bar has been described in the above embodiment, the present disclosure is not limited thereto. For example, the temperature sensor may be disposed in a portion of the power storage cell near the bus bar. In this case, the temperature sensor may be capable of detecting (estimating) the temperature of the bus bar. A signal indicating the temperature of the bus bar detected (estimated) by the temperature sensor may be transmitted to the detection module.

Although the module main body 41 of the detection module 40 is disposed at the position overlapping the cell module 10 in the Y direction in the above embodiment, the present disclosure is not limited thereto. For example, the module main body 41 (detection module 40) and the cell module 10 may be disposed to be shifted in the X direction or the Z direction.

Although the example in which the detection module 40a and the detection module 40b are included in the power storage device 100 has been described in the above embodiment, the present disclosure is not limited thereto. The power storage device may include only one of the detection module 40a and the detection module 40b.

In the above embodiment, the example in which each of the number of the temperature pins 42a and the number of the temperature pins 43a is equal to the sum of the number of the bus bars 23 whose temperature is detected by the temperature sensor 51 and the number of the bus bars 33 whose temperature is detected by the temperature sensor 52 has been described, but the present disclosure is not limited thereto. Each of the number of temperature pins 42a and the number of temperature pins 43a may be larger than the total. Further, the number of the temperature pins 42a may be equal to the number of the bus bars 23 whose temperature is detected by the temperature sensor 51, and the number of the temperature pins 43a may be equal to the number of the bus bars 33 whose temperature is detected by the temperature sensor 52.

Although the embodiments of the present disclosure have been described, it should be understood that the embodiments disclosed herein are illustrative and non-restrictive in all respects. The scope of the present disclosure is defined by the appended claims, and all changes which come within the meaning and range of equivalency of the claims are intended to be embraced therein.

What is claimed is:

1. A power storage device comprising:
a cell module including a plurality of power storage cells arranged in an arrangement direction;
a bus bar module electrically connected to the cell module;
a temperature detection unit; and
at least one detection module electrically connected to the temperature detection unit and disposed on one end side of the cell module in the arrangement direction, wherein
when it is defined that
a direction intersecting the arrangement direction is an intersecting direction,
one direction of the intersecting direction is a first direction, and
the other direction of the intersecting direction is a second direction,
the bus bar module includes
a plurality of first bus bars disposed on the first direction side with respect to a module center located at a center of the cell module in the intersecting direction, and
a plurality of second bus bars disposed on the second direction side with respect to the module center,
the temperature detection unit includes
a first temperature detection portion disposed on the first direction side with respect to the module center, the first temperature detection portion being able to detect a temperature of at least one of the plurality of first bus bars, and
a second temperature detection portion disposed on the second direction side with respect to the module center, the second temperature detection portion being able to detect a temperature of at least one of the plurality of second bus bars,
the detection module includes a module main body, and a first detection connector and a second detection connector each connected to the module main body,
the first detection connector is electrically connected to the first temperature detection portion and is disposed on the first direction side with respect to the module main body, and
the second detection connector is electrically connected to the second temperature detection portion and is disposed on the second direction side with respect to the module main body.

2. The power storage device according to claim 1, wherein the module main body is disposed at a position overlapping the cell module in the arrangement direction.

3. The power storage device according to claim 1, wherein
the at least one detection module includes
a first detection module disposed on one side with respect to the cell module in the arrangement direction, and
a second detection module disposed on the other side with respect to the cell module in the arrangement direction,
the first detection connector of the first detection module is electrically connected to the first temperature detection portion disposed on the one side with respect to a predetermined position in the arrangement direction,
the second detection connector of the first detection module is electrically connected to the second temperature detection portion disposed on the one side with respect to the predetermined position in the arrangement direction,
the first detection connector of the second detection module is electrically connected to the first temperature detection portion disposed on the other side with respect to the predetermined position in the arrangement direction, and
the second detection connector of the second detection module is electrically connected to the second temperature detection portion disposed on the other side with respect to the predetermined position in the arrangement direction.

4. The power storage device according to claim 1, wherein
the bus bar module includes
a first bus bar connector connected to the first detection connector,
a first printed board on which a first wiring that electrically connects the first bus bars and the first bus bar connector is formed,
a second bus bar connector connected to the second detection connector, and
a second printed board on which a second wiring that electrically connects the second bus bars and the second bus bar connector is formed,
the cell module includes
a first side surface on the first direction side in the intersecting direction, and
a second side surface on the second direction side in the intersecting direction,
the first printed board is disposed at a position facing the first side surface, and
the second printed board is disposed at a position facing the second side surface.

5. The power storage device according to claim 1, wherein
the first detection connector includes a first detection pin for temperature detection,
the second detection connector includes a second detection pin for temperature detection, and
each of the number of the first detection pins and the number of the second detection pins is equal to or greater than a sum of the number of the first bus bars for each of which a temperature is detected by the first temperature detection portion and the number of the second bus bars for each of which a temperature is detected by the second temperature detection portion.
